(19) United States
(12) Patent Application Publication
(10) Pub. No.: US 2023/0321648 A1
(43) Pub. Date: Oct. 12, 2023

(54) IMPROVEMENTS IN OR RELATING TO A DEVICE FOR ANALYSING A SAMPLE

(71) Applicant: VIDYA HOLDINGS LTD, London (GB)

(72) Inventors: Marko Dorrestijn, London (GB); David Rupert Klug, London (GB); Vladimir Turek, London (GB); Stefan Leo Van Workum, London (GB)

(73) Assignee: VIDYA HOLDINGS LTD, London (GB)

(21) Appl. No.: 18/022,323

(22) PCT Filed: Aug. 20, 2021
(86) PCT No.: PCT/GB2021/052169

§ 371 Date: Feb. 21, 2023

(30) Foreign Application Priority Data
Aug. 21, 2020 (GB) 2013085.2

(51) Int. Cl. B01L 3/00

(52) U.S. Cl. CPC B01L 3/5023; B01L 3/502746; B01L 2400/086; B01L 2200/16; B01L 2300/069; B01L 2300/0681; B01L 2300/0816

(57) ABSTRACT

A lateral to free flow assay device is provided for analysis of a fluid sample. The device comprises: a sample collection unit configured to introduce the sample into the device; an optical element configured to facilitate TIR for the analysis of the sample; a fluid pathway configured to provide fluid communication between the sample collection unit and a free flow region adjacent the optical element; a wicking pad defining a lateral flow section of the fluid pathway or provided in the sample collection unit to collect the sample; wherein at least one surface of the optical element defines at least part of the free flow region of the fluid pathway; and wherein the fluid pathway is configured to enable fluid flow from the lateral flow region to the free flow region of the fluid pathway to facilitate the analysis of the sample.

The present invention relates to improvements in or relating to a device for analysing a sample and in particular, a lateral to free flow assay device for analysis of a saliva sample.

A fluid sample such as a saliva sample is often collected in a non-sterile environment such as a home, workplace, domestic or retail setting by an unskilled user for diagnostic or research purposes.

Systems for collecting and analysing fluid sample exist in the literature and often involve a disposable cartridge and a reader. Devices used for the collection of fluid samples at the point-of-care such as disposable cartridges are usually utilised by unskilled operatives therefore such devices need to be intuitive to use and should be resilient.

Collected sample is either analysed immediately or stored and transported for later analysis. Bioassays are performed on the sample collected in certain disposable cartridges which are then inserted into a reader to detect specific biomarkers.

In order to quantify the levels of biomarkers in saliva samples, there needs to be a method of collecting the saliva from a user in an efficient manner at the point of care. The saliva sample must be transported internally to an analysis region at the appropriate volume of a collection device and the whole collection device must then be placed in a reading device for measurement.

It may be advantageous that the fluid sample is processed prior to analysis or storage to remove particulate matter. Particles within the sample may interfere with detection methods during analysis or reduce shelf-life of the collected sample.

Current enzyme-linked immunosorbent assays (ELISA) can be used to analyse the saliva sample provided by a user but ELISA assays often require expensive equipment, skilled personnel, and it has a long processing time.

Other devices may utilise lateral flow immunoassay immunoassays (LFIA) for analysing the saliva sample. Current lateral flow immunoassays (LFIA) devices use a wicking membrane. This membrane can provide excellent protein binding, blocks easily, and produces very low background in chemiluminescent Western blotting the material. However, when the wicking pad is combined with Total internal reflection (TIR) illumination it creates a lot of scatter and thus is not suited for TIR illumination. This is a significant problem especially when the detection reagent is in scatter but this is also a problem with fluorescence (TIRF) as high levels of scatter can still reach the detector despite light filtering.

Therefore, there is a requirement to provide a lateral to free flow assay device which has the simplistic and cost effective collection method of a lateral flow assay that can be combined with an ultra-sensitive read-out method such as TIR.

It is against this background that the present invention has arisen.

According to an aspect of the invention, there is provided a lateral to free flow assay device for analysis of a fluid sample, the device comprising: a sample collection unit configured to introduce the sample into the device; an optical element configured to facilitate TIR for the analysis of the sample; a fluid pathway configured to provide fluid communication between the sample collection unit and a free flow region adjacent the optical element; a wicking pad defining a lateral flow section of the fluid pathway or provided in the sample collection unit to collect the sample; wherein at least one surface of the optical element defines at least part of the free flow region of the fluid pathway; and wherein the fluid pathway is configured to enable fluid flow from the lateral flow region to the free flow region of the fluid pathway to facilitate the analysis of the sample.

The optical element may be configured to facilitate total internal reflection (TIR) by the fact that the optical element acts as a waveguide for TIR to occur. When the input light hits a surface of the optical element for example, a top surface of the optical element, above a critical angle, light can undergo TIR.

In some embodiments, the device further comprises a reservoir and the wicking pad is provided between the reservoir and the free flow region. The reservoir may be provided to accommodate a reasonable sample overflow, i.e. the part of the sample remaining once the analysis zone fills.

The fluid sample may be a saliva sample or it may be another sample of bodily fluid including, but not limited to a urine, sweat or mucus sample.

The sample needs to be introduced to the assay device and to flow through the device. The sample can be saliva. Alternatively or additionally, the sample can be a sputum sample, or a mucus sample, a blood, plasma, sweat or urine sample. The wicking pad can be provided to collect the sample and may additionally provide some level of filtration, which may or may not be augmented by other filters provided upstream and/or downstream of the wicking pad. The flow within the wicking pad is broadly described as “lateral” because there is a requirement for a bulk, semi-constrained movement of the sample, through the wicking pad and out into the free flow region. Once the wicking pad has been filled with the sample, the sample needs to flow along the fluid pathway out of the wicking pad and into the part of the fluid pathway that does not include the wicking pad. In the part of the pathway that does not include the wicking pad, the fluid sample can undergo reactions, binding, separation and analysis. The fluid therefore needs to move efficiently into this free flow part of the fluid pathway.

In some embodiments, the wicking pad may contain one or more reagents or other components intended to aid the efficient processing of the assay. In some embodiments, the reagents may be detection reagents. In some embodiments, the reagents may be a protein or a surfactant. Providing a protein or a surfactant could be beneficial to the assay because it can help to control the ionic strength and/or the pH of the sample. Furthermore, the protein and/or the surfactant reagent may also improve the flow properties of the sample. Additionally or alternatively, the surfactant can alter the surface tension at the interface of the sample, thus making it easier to flow the sample into the free flow region of the device. In some embodiments, a combination of the detection reagents and reagents such as protein or surfactant can be provided within the wicking pad.

The sample can be flowed through the wicking pad and, aside from removing large particulates from the sample, the wicking pad can also introduce one or more additional components into the sample. This can be advantageous because the wicking pad with one or more reagents can interact with a sample of interest.

The sample collection unit is configured to introduce the saliva sample into the device by being sized and shaped to provide a suitable for direct donation of a sample from the mouth of a user into the device. For example, the sample collection unit comprises an open receptacle that is sized to receive a sample of between 100 μl and 1 ml of saliva directly from the mouth of the user, although a larger sample, for example up to 5 ml could be donated. The sample collection unit may be oval shaped in plan view and may have a diameter or major axis that exceeds the height of the unit. This shape makes the unit appropriate for direct donation of a saliva sample into the unit.

The optical element is configured to receive and refract or reflect light so that a Total internal reflection (TIR) reading can be taken by an optical system that may be external to the device. Deployment of such an optical element places certain constraints on the optical properties of the constituent parts of the device.

For example, the wicking pad can create noise through scattering and therefore the wicking pad is located either in the sample collection unit or in the part of the fluid pathway that does not include the optical element. Alternatively, if the wicking pad does approach the part of the fluid pathway in which the evanescent field will be created by the optical element, then masking can be applied to provide shielding from scattering created by the wicking pad.

Total Internal Reflection (TIR) and Total Internal Reflection Fluorescence (TIRF) are capable of providing a very sensitive readout in a short time. In this context a short time means an assay with an on-rate in the order of seconds and a total elapsed time measured in minutes. This contrasts with the incubation time in the order of hours required by ELISA and similar assays.

In some embodiments, the wicking pad is also a conjugate pad. The wicking pad can be a conjugate pad which is impregnated with one or more type of particles or reagent relevant to the reactions intended to take place within the device. In this way, the wicking pad provides a dual function of filtering out large particles that might damage parts of the device or interfere with the functioning of the optical system and also introducing relevant particles to the saliva sample. The particles added may be detection reagents.

In some embodiments, the fluid pathway may have one or more walls and wherein at least part of at least one of the walls is provided with a mask.

The mask is provided to selective points on the walls to increase control of the fluid flow within the fluid pathway. The sample will preferentially move across the surface with the highest wetting coefficient and therefore if the masking has a lower wetting coefficient than the fluid pathway, the masking provides a preferential routing for air that fills the system before sample application and/or gas that has become entrained with the saliva sample, allowing it to escape from the device. The gas must exit and, without preferential pathways, the fluid flow will be inhomogeneous and may result in unwanted air pockets or bubbles in the free-flow region. Any air-sample interface, such as an air bubble or unwanted air pockets, within the evanescent field will create unwanted scatter degrading the readout. Furthermore, if the air pocket becomes trapped over a capture component, the sample would not contact the capture component and therefore there would be no assay and thus no result.

In some embodiments, at least part of one of the walls of the fluid pathway has a higher wetting coefficient than the wicking pad to optimise the fluid flow from the wicking pad into the free flow region of the fluid pathway.

The wall may be formed from a material that inherently has a positive wetting coefficient or the wetting coefficient may be rendered positive by the provision of a coating. In either case, the configuration and surface coating of the fluid pathway is selected such that the fluid sample overcomes the surface tension of the fluid sample and enables it to be drawn, primarily along the wall of the fluid pathway to fill the fluid pathway.

By applying the coating just to a part of the wall, a preferential pathway along which the fluid sample can be drawn primarily is created. This minimises the resistance to fluid flow and ensures efficient movement of the sample from the wicking pad into the free flow region of the fluid pathway.

In some embodiments, the coating may be a surfactant.

In some embodiments, a plurality of layers of coating can be provided. The layers of coating may be the same as one another or they may be different from one another in relation to their comparative wetting coefficient.

In some embodiments, one or more of the walls adjacent to the fluid pathway is provided with surface features to optimise fluid flow from the wicking pad into the free flow region of the fluid pathway.

The surface features may be macro-scale characteristics such as pillars, domes or dimples. Alternatively or additionally the surface features may be microscale features that provide surface roughness.

In some embodiments, the surface features are grooves.

In some embodiments, the free flow portion tapers along the fluid pathway. The tapering may be in either of the perpendicular directions to the direction of flow or both. The tapering may be gradual or it may be stepped. The tapering will change the capillary force and therefore contribute to the control over the fluid flow within the device.

In some embodiments, at least one wall of the fluid pathway can be fabricated from material with high wetting coefficient. Materials with a high wetting coefficient draw the fluid along the fluid pathway, out of the wicking pad and into the free flow region. This is because the high wetting coefficient of the material prevents the saliva sample from beading, but instead causes it to flow along the surface, drawing the sample out of the wicking pad and into the free flow region. Examples of materials with a suitable wetting coefficient include glass and some plastics such as PMMA and PC.

In some embodiments, at least one wall of the fluid pathway can be roughened to optimise fluid flow from the wicking pad into a free flow region of the fluid pathway.

Roughening the surface will accentuate the underlying characteristics of the surface. Roughening helps to guide the fluid flow within the device and then to direct the fluid when it reaches the free-flow region.

In some embodiments, the roughening can be mechanical. Mechanical roughening includes stamping, hot embossing and moulding techniques appropriate to the material and manufacturing process deployed.

In some embodiments, the roughening can be chemical.

In some embodiments, the roughening involves laser ablating selective areas.

In some embodiments, the free flow region of the fluid pathway includes one or more capture components.

The capture component deposited onto the surface within the free flow region can be used to bind onto a target component of interest such as a biomarker. Various examples of biomarkers include, but are not limited to, proteins such as immunoglobulins, CRP, NGAL, Leptin, Adiponectin, PIGF. Other markers include nucleic acids such as DNA and/or RNAs including microRNAs.

The capture component may be an antibody. Alternatively or additionally, the capture component could be a nucleic acid such as DNA, RNA, mRNA or microRNA, or chemically modified nucleic acid; it could be a protein, or a modified protein a peptide; or a polymer; it could be a hormone; or a tethered small molecule configured to capture a protein. Optionally, the capture component may be a nanoparticle or a quantum dot. In some embodiments, the capture component may be a non-specific capture component such as saliva or poly lysine.

In some embodiments, the capture components can be provided on the optical element.

In some embodiments, one or more detection reagents can be provided.

The detection reagent, which can be a secondary antibody, and can be bound with a label and disposed in various configurations. The detection reagents may be, but is not limited to, one or more of the following: a peptide, a protein, a protein assembly, an oligonucleotide, a polynucleotide, a modified oligonucleotide, a modified polynucleotide, an aptamer, a morpholino, a small molecule, a cell, a cell membrane, a viral particle, a glycan, a conjugated solid particle, a conjugated solid bead or a cofactor.

The label may be, but is not limited to, one or more of the following: a luminescence molecule, or a fluorescent molecule, or a phosphorescence molecule or a chemiluminescent molecule, or a Rayleigh molecule, or a Raman molecule, or a photon up conversion, or an enzyme and its substrate that produces a colorimetric signal, a metallic or inorganic particles e.g. nanoparticles, a polycyclic aromatic hydrocarbon, a metalized complex, a quantum dot or an ion. The ion may be an atomistic ion or a salt of an organic molecule.

The label can be attached to the detection reagent.

Additionally or alternatively, the detection reagent may comprise an antibody. In some instances, the detection antibody can be fluorescently labelled.

In some embodiments, the detection reagent(s) can be provided in the wicking pad.

In some embodiments, the detection reagent(s) can be provided in the free flow region of the fluid pathway.

In some embodiments, the device may further comprise a flow controller downstream of the free flow region of the fluid pathway. This configuration controls the speed of the fluid flow through the device in relation to either the gas exiting the device or liquid passing through the device.

In some embodiments, the flow controller is a vent. Alternatively or additionally, the flow controller may be a capillary stop or a narrow or tortuous path.

In some embodiments, the device may further comprise a filter upstream of the wicking pad.

In some embodiments, the device may further comprise an external pressure device configured to control the flow of the saliva sample through the wicking pad and pathway.

In some embodiments, the inherent configuration of the device may not be sufficient to enable the sample to flow through the device and therefore an external pressure source may be provided. The external pressure source may be positive and applied at the upstream part of the device. This could be a pump configured to provide positive pressure to the upstream end of the fluid pathway, effectively urging the sample through the system. Alternatively, or additionally, the closure of the lid may provide a positive pressure impulse to the device.

Additionally or alternatively, the external pressure source may be negative as applied at the downstream part of the device. For example a pump can be configured to provide a relative reduction in pressure at the downstream end of the fluid pathway, adjacent to the optical element, effectively drawing the sample through the device.

In some embodiments, the device may further comprise a second wicking pad downstream of the free flow region of the fluid pathway to draw the saliva sample through the device.

This changes the ‘force-balance’ in the system as a secondary pad would have higher capillary forces than the free-flow pathway and thus the fluid flow rate would increase once it reached this second pad, thus ‘controlling’ the flow here by speeding it up. Thus, this may makes timing assay easier.

In some embodiments, the device may further comprise an electro-wetting plate which may be in combination with a within the free flow region of the fluid pathway.

This can be overcome by the provision of an electric field to allow the assay to commence at a specific time. This embodiment optimises the timing of the assay as it will not commence until the electric field is applied.

In some embodiments, the device may further comprise an indicator to confirm that a sufficient sample has been provided.

The indicator may be a colour change in the wicking pad or the vent or a control line that may be incorporated in the free flow region of the fluid pathway that may be visible to the user. In some embodiments, a dye may be provided to enable a colour change.

In some embodiments, the device is enclosed within a housing. The housing separates the device from the environment, maintaining pressure and preventing uncontrolled introduction and egress of anything unconnected with the assay. The housing may comprise various openings through which the contents of the device can be controlled, such as the vent which enables the pressure within the housing to be controlled. Furthermore, the housing may further include at least one opening configured to enable light to enter the device and be incident on the optical element at or above the critical angle. The presence and positioning of this opening ensures that the optical element is configured to facilitate TIR for the analysis of the sample.

The present invention will now be further described, by way of example only, with reference to the accompanying drawings in which:

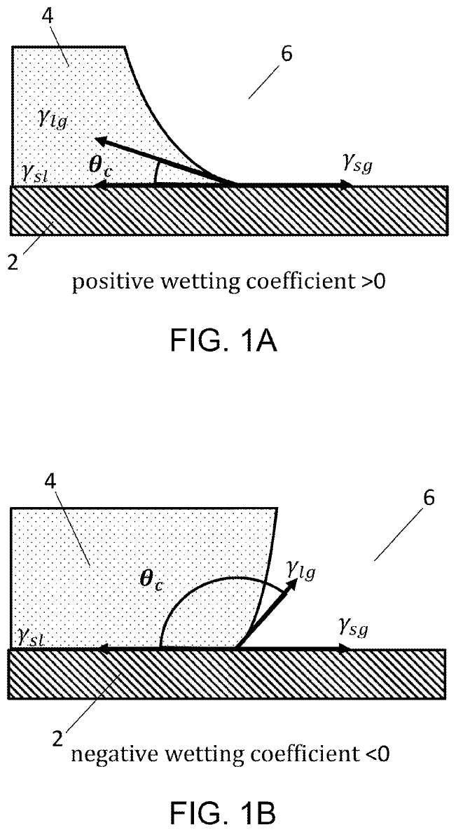

FIG. 1A provides an illustration of a positive wetting co-efficient according to the present invention;

FIG. 1B provides an illustration of a negative wetting co-efficient according to the present invention;

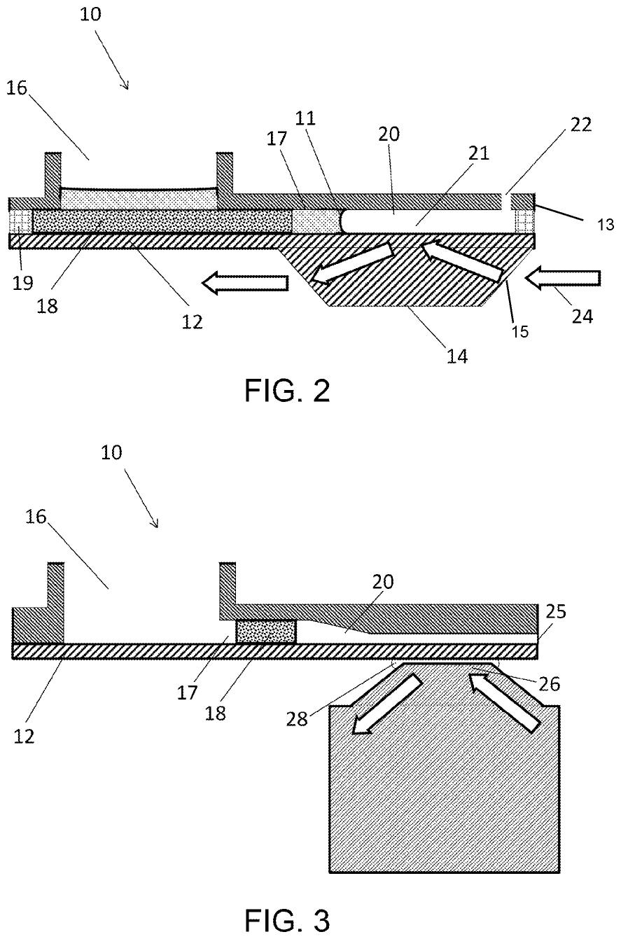

FIG. 2 shows a lateral to free flow assay device according to the present invention;

FIG. 3 shows an example of the lateral to free flow assay device according to FIG. 2 with a TIR set up;

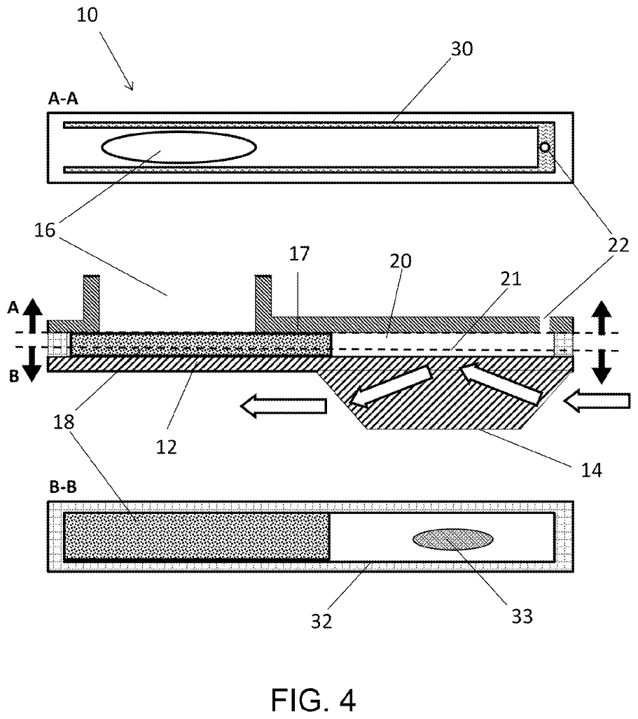

FIG. 4 shows an embodiment of the lateral to free flow assay device;

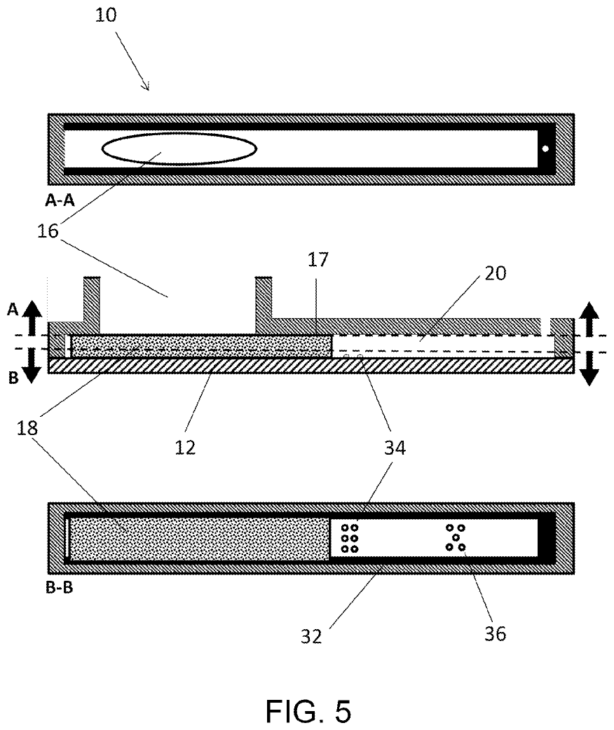

FIG. 5 shows an embodiment of the lateral to free flow assay device;

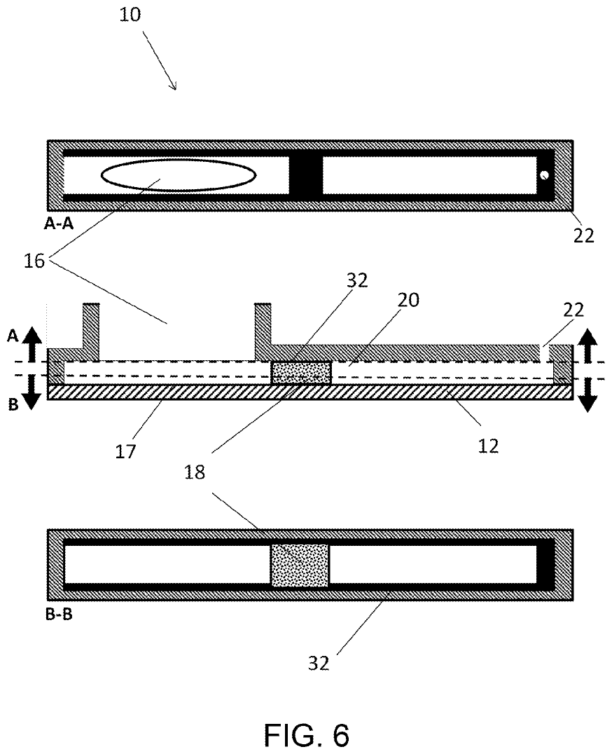

FIG. 6 shows an embodiment of the lateral to free flow assay device;

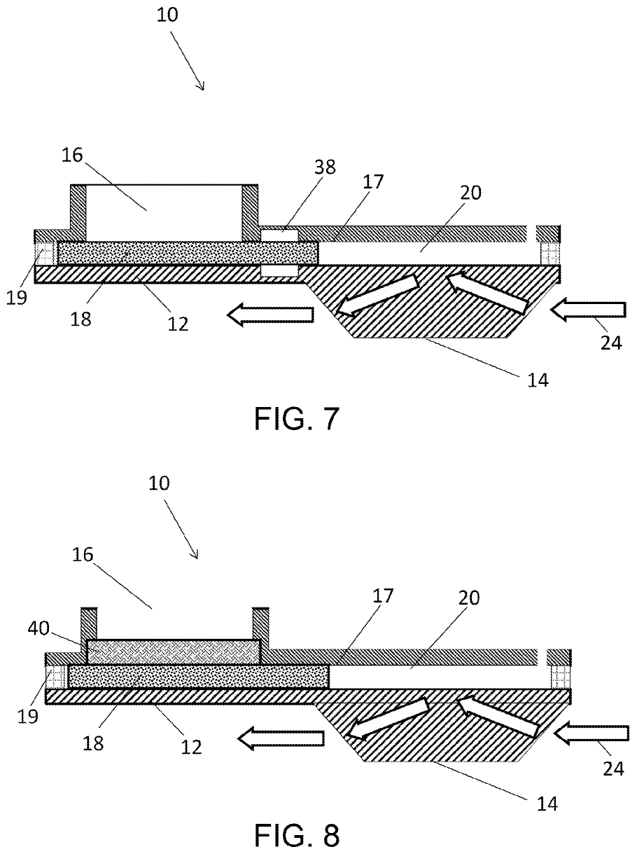

FIG. 7 provides a side view of the lateral to free flow assay device;

FIG. 8 provides a side view of the lateral to free flow assay device;

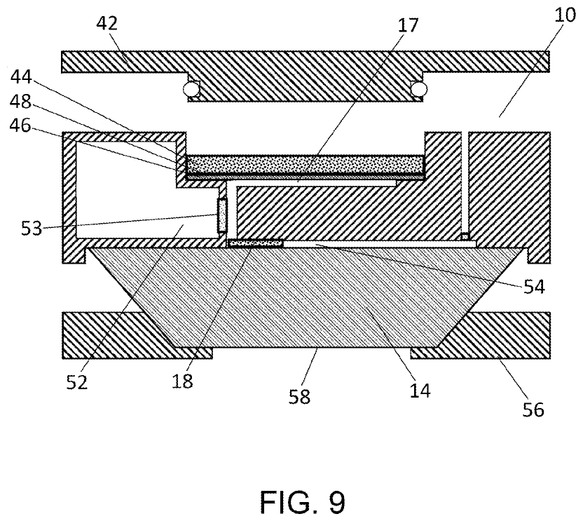

FIG. 9 shows an embodiment in which the device is incorporated into the lid;

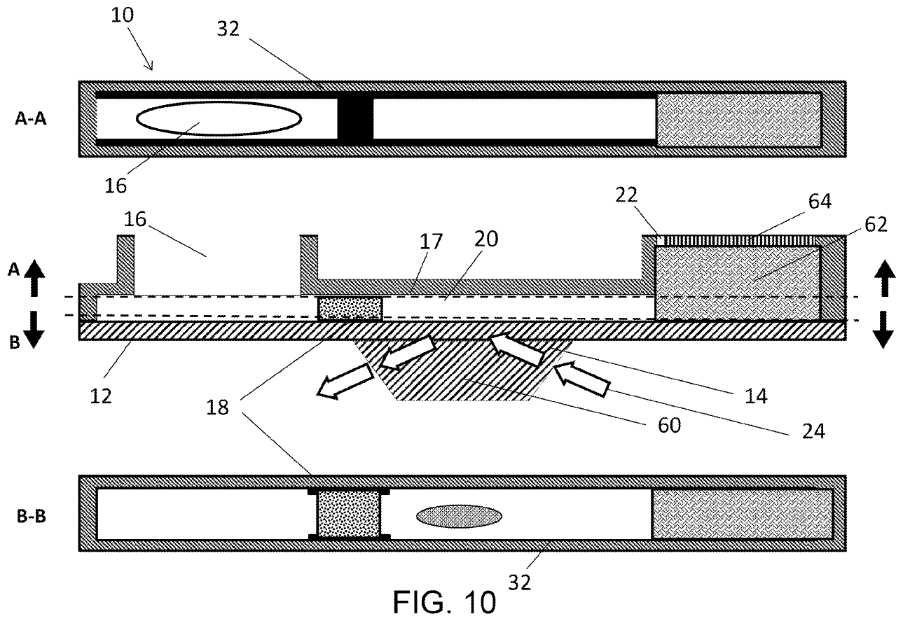

FIG. 10 shows an embodiment of the lateral to free flow assay device;

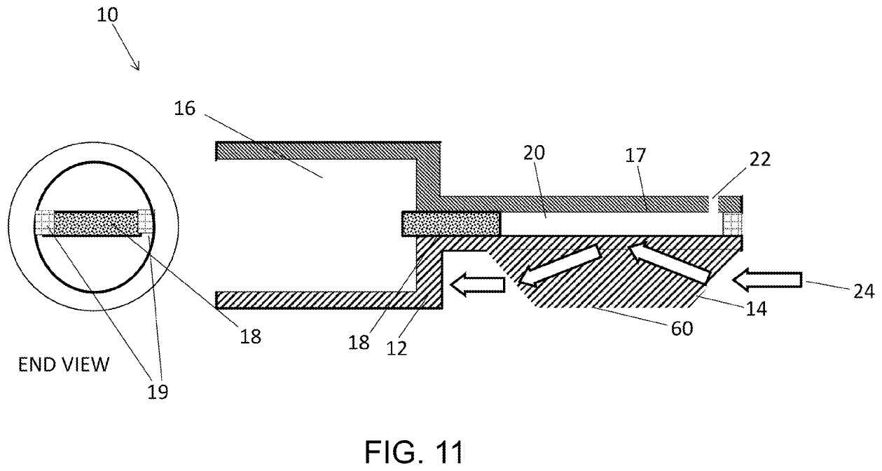

FIG. 11 shows an alternative geometry of the lateral to free flow assay device;

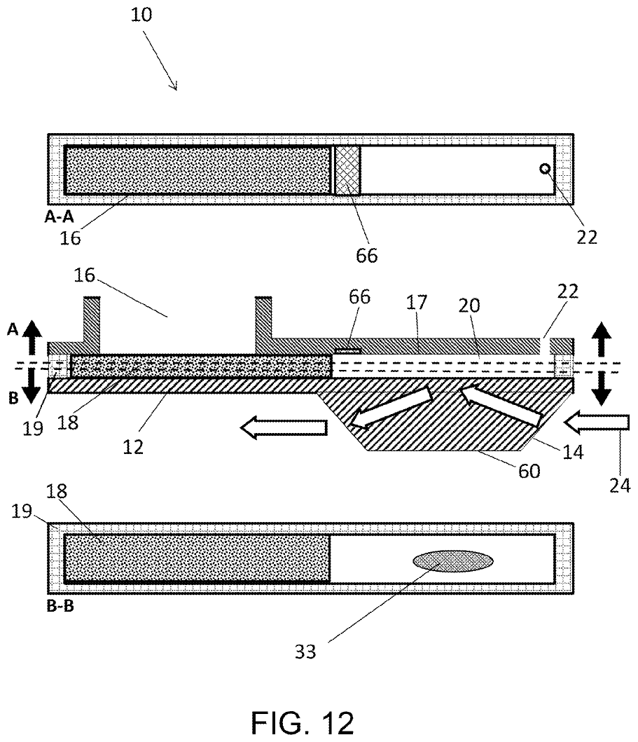

FIG. 12 shows the lateral to free flow assay device with electro-wetting element or coating;

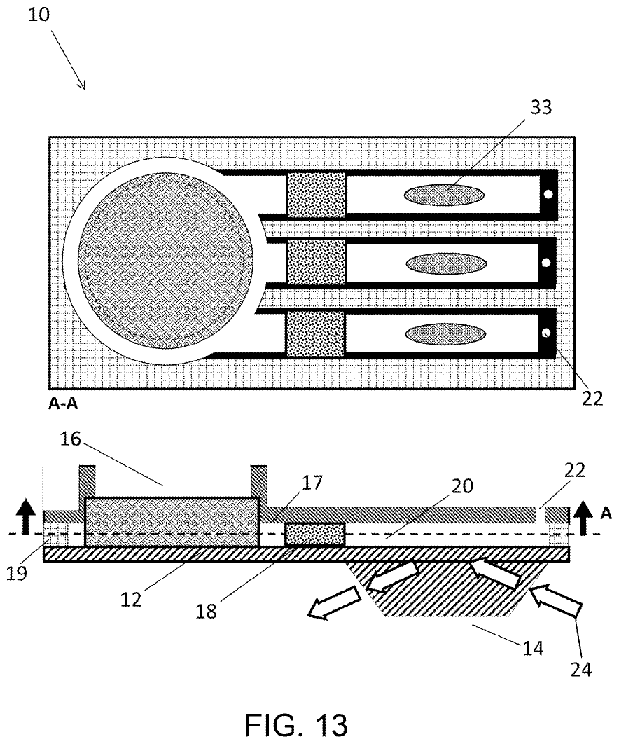

FIG. 13 provides an illustration of a multiplexed lateral to free flow assay device; and

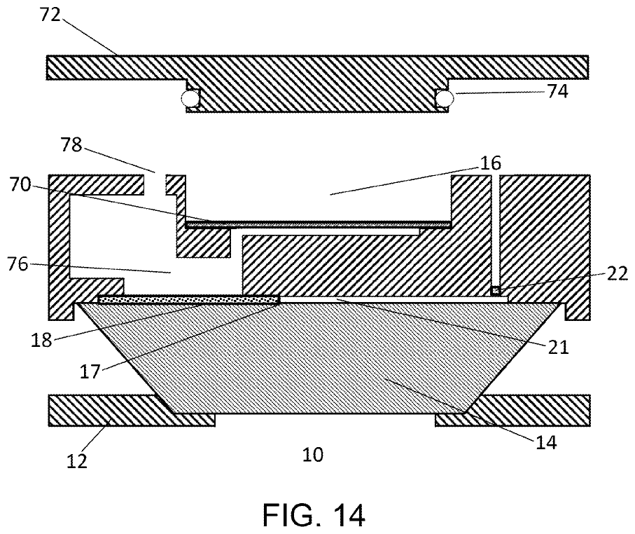

FIG. 14 shows an embodiment of the lateral to free flow assay device with additional sample handling elements.

Referring to FIGS. 1A and 1B, there is shown an illustration of a positive wetting coefficient and an illustration of a negative wetting coefficient. The wetting coefficient determines how a fluid behaves at the boundary between solid 2, liquid 4 and gas 6 and is dependent on the three surface tensions as defined by the equation below.

$$wetting coefficient = cos ( {θ}_{c} ) = \frac{( {γ}_{s g} - {γ}_{s l} )}{{γ}_{l g}}$$

wherein the terms are defined as:
θ_{c}=contact angle;
γ_{lg}=liquid-gas surface tension;
γ_{sg}=solid-gas surface tension; and
γₛₗ=solid-liquid surface tension.

The wetting coefficient can range from −1 to 1 with positive coefficients indicating a tendency for the liquid to spread out and wet a surface. Altering properties of the surface or the fluid can alter the respective surface tensions, thus a wetting coefficient cannot be calculated without taking into account all surface tensions. In some instances, applying a surfactant can alter surface tensions greatly. The surface tension may be dependent on temperature. In addition, a solute can have different effects on the surface tension.

Referring to FIG. 2, there is shown a lateral to free flow assay device 10. The device 10 is a handheld or portable device encased in a housing 13. The lateral to free flow assay device 10 comprises a substrate 12 whereby the substrate can be made out of glass or plastic. A portion or part of the substrate 12 can be an optical element 14. As shown in FIG. 2, the optical element is in a prism configuration that can be suitable for total internal reflection (TIR). The substrate 12 can be a polymer prism where the bottom face may be a lens shape.

The device 10 can further comprise a sample collection unit which is configured to introduce the saliva sample into the device by being sized and shaped to provide a suitable medium for direct donation of a liquid sample from the mouth of a user into the device. For example, the sample collection unit comprises an open receptacle 16 that is sized to receive a sample of between 100 μl and 1 ml of a saliva sample directly from the mouth of the user. As shown in FIG. 2, the receptacle 16 is configured to receive the liquid sample and as such, the liquid sample can then be introduced into the device 10. One or more detection reagent could be provided within a wicking membrane or pad 18, as shown in FIG. 2. In some embodiments, the detection reagent provided within the wicking pad 18 is a dry detection reagent. A double sided adhesive tape 19 is provided around the device 10 to seal against the sample leaking. The adhesive tape can be approximately 100 μm thick.

A liquid sample provided at the receptacle 16 can move through the device 10 under the influence of a total driving pressure. The factors which define the movement of a liquid boundary 11, as shown in FIG. 2, which travels towards the capture component spots comprising the total driving pressure are as follows: the external pressure, the three classes of interfacial tension and friction. External pressure can be upstream of the liquid boundary: hydraulic or pneumatic pressure upstream and pressure exerted on the liquid by gravity; or downstream of the liquid boundary: hydraulic or pneumatic suction. Ideally, gravity is negligible to allow for any tilt during operation. The three classes of interfacial tension are solid-liquid, liquid-gas, gas-solid; and there can be, for example, more than one liquid-solid interfacial tension present when there are different materials used in different parts of the device. Finally there is friction, which can be defined here as the viscous losses in the liquid. Any ‘static’ friction is subsumed into the interfacial tensions.

There is a force balance between the forces at each end of the wicking pad(s) 18 which can dictate the direction of flow of the liquid sample. Factors such as the porosity and hence resistance of the wicking membrane(s) or pad 18 or the viscosity of the sample may dictate the speed at which this flow can occur but not the resulting direction. An upstream liquid surface is provided at the receptacle 16 in which a capillary force can be created which may be due in part to excess liquid sample provided on the receptacle 16. A fluid pathway 17 comprising the wicking pad 18 may also provide a capillary force created by the equivalent diameter of the fluid pathway 17. The liquid sample can move through the system under the influence of the total driving pressure. As the liquid sample moves through the wicking pad 18, the liquid sample can come into contact with one or more detection reagents.

A portion of the free flow region 20 comprises an analysis region 21 as indicated in FIG. 2. The analysis region 21 can contain one or more capture components in free flow i.e. no porous wicking material. The free flow portion 20 containing one or more capture components is provided directly above of the optical element 14 as shown in FIG. 2. The lateral to free flow assay device 10 also comprises a vent hole 22. The vent hole 22 may be provided in the housing 13 to enable air, or inert gas, contained within the device 10 prior to the introduction of the liquid sample, to exit the device 10 as the sample is introduced. This prevents a build-up of pressure within the device 10 when the liquid sample moves along the device under the influence of the total driving pressure.

A collimated beam 24 can provide light to pass into the housing 13 through an opening 15 and subsequently through the optical element 14. The light can be emitted, refracted or scattered from the label associated with the detection reagent in the free flow portion 20.

Referring to FIG. 3, there is provided an apparatus set up suitable for an objective launched TIR. The set up comprises a lateral to free flow assay device 10 comprising a substrate 12, a receptacle 16 and a fluid pathway 17. A liquid sample is provided at the receptacle 16 and the liquid sample is then configured to move along the device under the influence of the total driving pressure towards the free flow portion 20 of the device 10. The fluid pathway 17 comprises a wicking pad 18 where one or more detection reagents are stored and a free flow portion or region 20 where one or more capture components are present. The free flow portion 20 tapers along the fluid pathway. The tapering may be in either of the perpendicular directions to the direction of flow or both. The tapering may be gradual or it may be stepped. The tapering can change the capillary force and therefore contribute to the control over the fluid flow within the device 10. The liquid sample can be stopped within the device by the use of a capillary stop 25 as illustrated in FIG. 3.

A lens 26 such as an objective lens can be provided and an index matching fluid 28 such as an index matching oil is provided between the objective lens 26 and the substrate 12 as illustrated in FIG. 3. The objective lens is configured to launch an excitation light towards the substrate and collect the emitted, reflected or scattered light from the free flow region. Providing an objective lens can be advantageous because it allows the apparatus to achieve detection with single molecule sensitivity and it may provide a large dynamic range of the order of 106.

In some embodiments, the apparatus can include a detector (not shown in the accompanying drawings) which is provided to detect the emitted light from the label associated with the detection reagent. Additionally or alternatively, the detector can be used to detect scattered light such as Raman scattering, Rayleigh scattering, Mie scattering and/or upconversion.

Objective based TIR imaging such as TIRF imaging requires refractive index matching fluid 28 such as an index matching oil in between the substrate 12 and the objective lens 26 to achieve TIR. In some instances, the thickness of index matching oil between the lens and the substrate needs to be maintained. Oil is an ideal index matching fluid because the refractive index can be the same or similar as the substrate that is made out of glass. Alternatively or additionally, an index matching solid or an index matching gel can be provided.

Referring to FIG. 4, there is provided a side section view and two plan section views of the lateral to free flow assay device 10. The lateral to free flow assay device 10 comprising a substrate 12, a receptacle 16 and a fluid pathway 17. A liquid sample is provided at the receptacle 16 and the liquid sample is then configured to move along the device under the influence of the total driving pressure towards the free flow portion 20 of the device 10. The fluid pathway 17 comprises a wicking pad 18 where one or more detection reagents are infused within the wicking pad 18 and a free flow portion or region 20 where one or more capture components are present.

A portion of the substrate 12 may be an optical element with a prism configuration 14 where light can enter and/or exit. This configuration makes it suitable for TIR. The evanescent field 33 created by the beam undergoing TIR at the analysis region 21 as indicated in FIG. 4 is provided within the free flow portion 20 of the device 10. A vent hole 22 is provided on the device 10 to allow air to escape the device. As indicated in FIG. 4, at least one wall such as the top wall of fluid pathway 30 can be roughened with surface texture around the edge to allow air to escape to the vent hole 22. Roughening the surface will accentuate the underlying characteristics of the surface so that a negative wetting co-efficient surface will become more negative and, conversely, a positive wetting co-efficient surface will become more positive.

Referring to FIG. 5, there is provided a side section view and two plan section views of the lateral to free flow assay device 10. This device differs from conventional lateral flow devices by the provision of a free flow region in which the analysis of the sample takes place. Conventional lateral flow devices do not have a free flow region, but instead have a wicking material or matrix in the analysis zone. This material or matrix will scatter light which is incident on it and this scattering can both reduce the signal available for measurement and create a substantial background, which makes it hard to detect the signal with high sensitivity and high dynamic range. Variability of the scatter means that it can also be hard to quantify the signal with high accuracy and precision. This is highly disadvantageous when accuracy and precision are requirements for interpretation of the analysis signal. The presence of a matrix can also interfere with the function of TIR by creating a modulated and variable refractive index at the interface.

The lateral to free flow assay device 10 comprising a substrate 12, a receptacle 16 and a fluid pathway 17. A liquid sample is provided at the receptacle 16 and the liquid sample is then configured to move along the device under the influence of the total driving pressure towards the free flow portion 20 of the device 10. The fluid pathway 17 comprises a wicking pad 18. The wicking pad 18 can be provided to collect the sample and may additionally provide some level of filtration. One or more detection reagents 34 can be provided within the free flow region of the device. The detection reagents can be deposited i.e. printed onto the surface of the substrate 12 in the free flow portion 20 of the device 10. The detection reagent 34 can be in liquid droplet form or dried form. The substrate can be made out of glass such as a glass coverslip which is suitable for TIR. Alternatively, the substrate can be made out of plastic.

The coverslip can be suitable for TIR because it is formed from a suitable material to enable it to act as a waveguide for TIR. The coverslip is suitable for TIR within the device as a result of the size, shape and mounting location of the coverslip as well as the allowance for light to enter the chip through one or more recesses or holes in the exterior of the chip. Alternatively, an objective lens may be provided. An input light can be provided in which the light can enter through the bottom face of the objective lens.

The input light hits a surface of the coverslip, for example a top surface of the coverslip, above a critical angle as defined by Snell's law and as the substrate has a sufficiently higher refractive index than the refractive index of the liquid sample, this results in the incident light undergoing TIR even once the sample has entered the free-flow region. For example, the refractive index (RI) of the substrate, i.e. silica RI is approximately 1.47 and borosilicate RI is approximately 1.51, is sufficiently higher than the refractive index of the saliva or water sample, which has an RI of approximately 1.33.

The substrate can be a coverslip, microscope slide or a thick piece of glass. The coverslip may be made out of glass or plastic. A portion of the substrate 12 may comprise a prism. As shown in FIG. 5, one or more capture components 36 can be deposited on the surface of the substrate 12 in the free flow region 20 of the device 10.

At least one of the walls of the fluid pathway 17 is provided with a mask 32. The mask 32 is provided to selective points on the walls of the fluid pathway 17 to increase control of the fluid flow within the fluid pathway 17. Furthermore, if the masking 32 is has a lower wetting coefficient than the fluid pathway 17, the masking 32 provides a preferential routing for air that fills the system before sample application and/or gas that has become entrained with the saliva sample, allowing it to escape from the device 10.

Referring to FIG. 6, there is provided a lateral to free flow assay device 10. The lateral to free flow assay device 10 comprising a substrate 12, a receptacle 16 and a fluid pathway 17. A liquid sample is provided at the receptacle 16 and the liquid sample is then configured to move along the device under the influence of the total driving pressure towards the free flow portion 20 of the device 10. The fluid pathway 17 comprises a wicking pad 18. The wicking pad 18 can be provided to collect the sample and may additionally provide some level of filtration. In addition, one or more detection reagents can be provided within the wicking pad 18.

A mask 32 can be applied to the top and/or bottom of the wicking pad 18. By masking underneath the wicking pad 18, it may stop fluids flowing along the fluid pathway 17 from bypassing the wicking pad 18. Additionally, at least one of the walls of the fluid pathway 17 is provided with the mask 32. The mask 32 is provided to selective points on the walls of the fluid pathway 17 to increase control of the fluid flow within the fluid pathway 17. A vent hole 22 is provided at the end of the device 10 to allow air to escape out. An adhesive such as glue or an adhesive tape can be provided around the device 10. The adhesive tape can be approximately 100 pm. It will be appreciate that the figures are not to scale in this regard and the thickness of the tape is exaggerated for illustrative purposes.

Referring to FIG. 7, there is provided an illustration of an alternative embodiment of the lateral to free flow assay device 10. The lateral to free flow assay device 10 comprising a substrate 12, a receptacle 16 and a fluid pathway 17. A liquid sample is provided at the receptacle 16 and the liquid sample is then configured to move along the device under the influence of the total driving pressure towards the free flow portion 20 of the device 10.

The fluid pathway 17 comprises a wicking pad 18. The wicking pad 18 can be provided to collect the sample and may additionally provide some level of filtration. In addition, one or more detection reagents can be provided within the wicking pad 18. An air gap 38 can be provided at the top and/or at the bottom of the wicking pad 18. By providing an air gap 38 below the wicking pad 18 as shown in FIG. 7 instead of a mask, it ensures that the liquid sample will go through the wicking pad 18 and does not by bypass the wicking pad 18. This ensures that the liquid sample would be in contact with the detection reagents provided within the wicking pad 18.

As illustrated in FIG. 7, a portion of the substrate 12 may comprise an optical element with a prism configuration 14. A collimated beam 24 can provide light to pass through the optical element with a prism arrangement 14 and the light can be emitted, refracted or scattered from the liquid sample in the free flow portion 20. A double sided adhesive tape 19 is provided around the device 10. The adhesive tape can be approximately 100 μm.

Referring to FIG. 8, there is shown a lateral to free flow assay device 10 comprising a substrate 12, a receptacle 16 and a fluid pathway 17. A liquid sample is provided at the receptacle 16 and the liquid sample is then configured to move along the device under the influence of the total driving pressure towards the free flow region or portion 20 of the device 10. The fluid pathway 17 comprises a wicking pad 18 where one or more detection reagents are provided within the wicking pad 18.

As shown in FIG. 8, an additional pad 40 may be provided at the receptacle 16. The additional pad 40 can be provided on top of the wicking pad 18. The additional pad 40 can be utilised for filtering out unwanted components from the saliva sample such as mucin before the saliva sample contacts the wicking pad 18.

As illustrated in FIG. 8, a portion of the substrate 12 may comprise an optical element with a prism configuration 14. The prism-shaped optical element 14 may be a polymer prism substrate suitable for TIR. A collimated beam 24 can provide light to pass through the optical element with a prism arrangement 14 and the light can be emitted, refracted or scattered from the liquid sample in the free flow portion 20. A double sided adhesive tape 19 is provided around the device 10. The adhesive tape can be approximately 100 μm.

FIG. 9 shows an example in which the device 10 is incorporated into the lid 42. In the illustrated example, the presence of the pad 44 is not essential to this configuration as the filtration functionality of the pad 44 can be provided elsewhere within the device. For example, a separate filter 46 can be provided in the device so that the sample is filtered once the lid 42 is closed and the sample is introduced. Additionally, or alternatively, there may be provided a protective layer 48 over top of the separate filter 50. The provision of the filter 46 within the device or the provision of the protective layer 48 to provide separation both protect the it from accidental damage by the user. The protective layer 48 may take the form of a very coarse grain filter with large entry holes. In other embodiments, not illustrated, the protective layer could be a semi permeable membrane or just a single large entry hole.

Although not optimised for use by an unskilled operative and therefore less appropriate for a point of care scenario, it is possible to implement the configuration as illustrated in FIG. 9. The illustrated embodiment shows a large reservoir 52 that has an entrance zone 53 that can maintain fluid communication between the reservoir and the fluid pathway 17. The reservoir 52 can accommodate a reasonable sample overflow, i.e. the part of the sample remaining once the analysis zone 54 is filled, without a substantial increase in pressure arising from the compression of the gas within the reservoir 52.

A wicking pad 18 is provided within the fluid pathway 17 where one or more detection reagents can be provided within the wicking pad 18. The substrate can be an optical element with a prism configuration 14. The optical element can be made from glass or polymer. The optical element 14 can sit within a holder 56. The holder may comprises one or more holes for screws. The holder 56 also includes a viewing aperture 58 through which the transmitted, reflected or scattered light can be observed.

In some instances, the wicking pad 18 may be provided between the reservoir 52 and the free flow region 20.

An external pressure may be provided to create pressure upstream of the wicking pad 18. The external pressure can be created by the closing of the lid 42. The extermal pressure created contributes to the total driving pressure of the liquid sample and causes the liquid sample to flow through the fluid pathway 17. Additionally or alternatveily, the external pressure may also be provided by a pressure source such as a pump.

Referring to FIG. 10, there is provided an illustration of the lateral to free flow assay device 10. The lateral to free flow assay device 10 comprising a substrate 12, a receptacle 16 and a fluid pathway 17. A liquid sample is provided at the receptacle 16 and the liquid sample is then configured to move along the device under the influence of the total driving pressure towards the free flow portion 20 of the device 10.

As illustrated in FIG. 10, a portion of the substrate 12 may comprise an optical element with a prism configuration 14. The bottom surface of the prism 60 may be a suitable surface for collecting emitted, reflected or scattered light. The bottom surface of the prism 60 may be a flat surface or it could be a lens to collect light emitted, scattered and/or reflected light in a detector. A collimated beam 24 can provide light to pass through the optical element with a prism arrangement 14 and the light can be emitted, refracted or scattered from the liquid sample in the free flow portion 20.

The fluid pathway 17 comprises a wicking pad 18. The wicking pad 18 can be provided to collect the sample and may additionally provide some level of filtration. Moreover, one or more detection reagents can be provided within the wicking pad 18. A mask 32 can be applied to the top and/or bottom of the wicking pad 18. By masking underneath the wicking pad 18, it may stop leaking of the fluids flowing along the fluid pathway 17 and out of the device 10. Additionally or alternatively, at least one of the walls of the fluid pathway 17 is provided with the mask 32. The mask 32 is provided to selective points on the walls of the fluid pathway 17 to increase control of the fluid flow within the fluid pathway 17. A vent hole 22 is provided at the end of the device 10 to allow air to escape out.

The configuration as shown in FIG. 10 further comprising a second wicking pad 62 provided downstream of the free flow region 20 of the fluid pathway 17 to draw the saliva sample through the device 10. The second wicking pad 62 can be an absorptive pad. Providing a second wicking pad 62 can be advantageous because the second wicking pad 62 changes the total driving pressure in the system as a secondary pad would have higher capillary forces than the free-flow pathway. Thus, the fluid flow rate would increase once it reached this second pad, thus ‘controlling’ the flow here by speeding it up. Therefore, this may makes timing assay easier.

Furthermore, the device 10 as illustrated in FIG. 10 further comprises a viewing window 64. The viewing window 64 can be transparent and is configured to provide an indication of the liquid sample that has filled the device. This provision of a positive indication that sufficient sample has been collected gives confidence to the user and also reduces the failure rate in connection with insufficient sample.

In some embodiments, the positive indication can be one or more of a colour change or a transparency change. A colour change is easily understandable to the unskilled user and makes the device user friendly. The changes may be deployed together so that the transparency of the pad changes when sufficient sample has been collected and this increase in transparency allows a coloured backing to become visible to the user. So, the user perceives a colour change, but this has been facilitated by a change in transparency the pad of porous material.

Referring to FIG. 11, there is provided an alternative embodiment of the lateral to free flow assay device 10. The lateral to free flow assay device 10 comprising a substrate 12, a receptacle 16 and a fluid pathway 17. In this geometry, the orientation of the receptacle is rotated at 90° C. In some instances, the receptacle can be held in any orientation. A liquid sample is provided at the receptacle 16 and the liquid sample is then configured to move along the device under the influence of the total driving pressure towards the free flow portion 20 of the device 10.

The fluid pathway 17 comprises a wicking pad 18. The wicking pad 18 may comprise one or more detection reagents such that when the liquid sample flows through the wicking pad 18, the liquid sample comes into contact with one or more detection reagents. A vent hole 22 is provided at the end of the device 10 to allow air to escape out.

As illustrated in FIG. 11, a portion of the substrate 12 may comprise an optical element with a prism configuration 14 suitable for TI R. The prism can be made from polymer. The bottom surface 60 of the prism 14 may be of any shape but preferably, the bottom surface is flat. A collimated beam 24 can provide light to pass through the optical element with a prism arrangement 14 and the light can be emitted, refracted or scattered from the liquid sample in the free flow portion 20. A double sided adhesive tape 19 is provided around the device 10. The adhesive tape can be approximately 100 μm.

Referring to FIG. 12, there is shown a lateral to free flow assay device 10. The lateral to free flow assay device 10 comprising a substrate 12, a receptacle 16 and a fluid pathway 17. As illustrated in FIG. 12, a portion of the substrate 12 may comprise an optical element with a prism configuration 14. The prism can be made from glass or polymer. The bottom surface 60 of the prism 14 may be of any shape but preferably, the bottom surface is flat. This configuration makes it suitable for TIR. A liquid sample is provided at the receptacle 16 and the liquid sample is then configured to move along the device under the influence of the total driving pressure towards the free flow portion 20 of the device 10. In some instances, the liquid sample can flow towards the evanescent field boundary 33 created by the optical element 14.

The fluid pathway 17 comprises a wicking pad 18. The wicking pad 18 may comprise one or more detection reagents such that when the liquid sample flows through the wicking pad 18, the liquid sample comes into contact with one or more detection reagents. A vent hole 22 is provided at the end of the device 10 to allow air to escape out.

A collimated beam 24 can provide light to pass through the optical element with the prism arrangement 14 and the light can be emitted, refracted or scattered from the liquid sample in the free flow portion 20. A double sided adhesive tape 19 is provided around the device 10. The adhesive tape can be approximately 100 μm.

An electro-wetting element or coating 66 is provided on at least one of the walls of the fluid pathway 17 of the device 10 as indicated in FIG. 12. The electro-wetting element or coating 66 can be connected to a voltage source (not shown in the accompanying drawings). The voltage source may be part of the device or it may be an external voltage source that is connectable to the device. Applying a voltage across the electro-wetting element or coating 66 changes the wetting co-efficient on the surface of the wall of the fluid pathway 17. For example, when a voltage is applied to the electro-wetting element or coating 66, it creates a positive wetting co-efficient on the surface of the wall of the fluid pathway 17. This in turn, enables the liquid sample to flow along the fluid pathway 17. Conversely, when no voltage is applied to the electro-wetting element or coating 66, the surface of the walls of the fluid pathway 17 has a negative wetting co-efficient, which can prevent the liquid sample from flowing along the fluid pathway 17. Thus, the electro-wetting element or coating can provide a temporary barrier to the flow of the liquid sample along the fluid pathway 17.

Referring to FIG. 13, there is provided an embodiment of a multiplexed lateral to free flow assay device. In this example, a single receptacle 16 may be provided and is connectable to three different fluid pathways 17. Each of the fluid pathways 17 comprises a wicking pad 18 and a free flow region 20 where the evanescent field 33 is created. The wicking pad 18 may comprise one or more detection reagents such that when the liquid sample flows through the wicking pad 18 under the influence of the total driving pressure, the liquid sample comes into contact with one or more detection reagents. A vent hole 22 is provided at the end of the device 10 to allow air to escape out.

As illustrated in FIG. 13, a portion of the substrate 12 may comprise an optical element with a prism configuration 14. The prism can be made from glass or polymer. A collimated beam 24 can provide light to pass through the optical element with a prism arrangement 14 and the light can be emitted, refracted or scattered from the liquid sample in the free flow portion 20. A double sided adhesive tape 19 is provided around the device 10. The adhesive tape can be approximately 100 μm.

Referring to FIG. 14, there is shown an embodiment of the lateral to free flow assay device 10. The lateral to free flow assay device 10 comprises a substrate 12 whereby the substrate 12 can be made out of glass or plastic. A portion or part of the substrate 12 is an optical element 14. As shown in FIG. 14, the optical element 14 is a prism that is suitable for total internal reflection (TIR). And there is an opening in one or both sides that allows light to enter at such an angle as to allow for TIR at the top surface of the optical element

The lateral to free flow assay device 10 further comprises a receptacle 16 and a fluid pathway 17. A liquid sample is provided at the receptacle 16 and the liquid sample then moves along the device under the influence of the total driving pressure towards the free flow portion 20 of the device 10. The fluid pathway 17 comprises a wicking pad 18. The wicking pad 18 collects the sample and may additionally provide some level of filtration. Moreover, one or more detection reagents can be provided within the wicking pad 18. The free flow region 20 comprises an analysis region 21 which is co-terminus with the free flow region 20 in this example. In other example, such as that illustrated in FIG. 3, the free flow region 20 is extended beyond the analysis region 21. One or more capture components are provided on the wall of the analysis region 21 i.e. not within the porous wicking material. The free flow portion 20 containing one or more capture components is deposited and more specifically, provided directly above of the optical element 14 as shown in FIG. 14. A vent hole 22 is provided at the end of the device 10 to allow air to escape out. Additionally or alternatively, the vent hole 22 can also act as a flow stop once the sample is introduced.

As illustrated in FIG. 14, additional sample handling elements are provided upstream of the wicking pad 18, including a receptacle 16 with an additional filter membrane 70. A lid or plunger 72 is also provided. The lid or plunger 72 is designed to form a seal with an O-ring 74, in use, in order to filter the sample before it is pushed into a reservoir 76. As shown in FIG. 14, a further vent 78 can be provided at the reservoir 76. This embodiment is particularly advantageous because the additional filter membrane 70 can be used to partially or completely filter out unwanted particles from the sample before the sample reaches the wicking pad 18. For example, large particles within the sample could block the membrane pores and create additional resistance to the fluid passing through the membrane and into the free-flow region for analysis. Hence, one of the benefits of this embodiment as illustrated in FIG. 14, is that larger particles and mucins are removed from the saliva sample before the sample comes into contact with the wicking pad 18.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1. A lateral to free flow assay device for analysis of a fluid sample, the device comprising:
a sample collection unit configured to introduce the sample into the device;
an optical element configured to facilitate TIR for the analysis of the sample;
a fluid pathway configured to provide fluid communication between the sample collection unit and a free flow region adjacent the optical element;
a wicking pad defining a lateral flow section of the fluid pathway;
wherein one or more reagents are provided in the wicking pad;
wherein at least one surface of the optical element defines at least part of the free flow region of the fluid pathway; and
wherein the fluid pathway is configured to enable fluid flow from the lateral flow region to the free flow region of the fluid pathway to facilitate the analysis of the sample.

2-4 (canceled)

5. The device according to claim 1, wherein the fluid pathway has one or more walls and wherein at least part of one of the walls of the fluid pathway has a positive wetting coefficient to optimise the fluid flow from the wicking pad into the free flow region of the fluid pathway.

6. (canceled)

7. The device according to claim 1, wherein the fluid pathway is provided with a plurality of layers of coating.

8. The device according to claim 1, wherein one or more of the walls adjacent to the fluid pathway is provided with surface features to optimise fluid flow from the wicking pad into the free flow region of the fluid pathway.

9. The device according to claim 8, wherein the surface features are grooves.

10. The device according to claim 1, wherein the free flow portion tapers along the fluid pathway.

11. The device according to claim 1, wherein at least one wall of the fluid pathway is fabricated from material with a positive wetting coefficient.

12. The device according to claim 1, wherein at least one wall of the fluid pathway is roughened to optimise fluid flow from the wicking pad into a free flow region of the fluid pathway.

13-15 (canceled)

16. The device according to claim 1, wherein the free flow region of the fluid pathway includes one or more reagents.

17-20 (canceled)

21. The device according to claim 1, further comprising a flow controller downstream of the free flow region of the fluid pathway.

22. The device according to claim 21, wherein the flow controller is a vent.

23. The device according to claim 1, further comprising a filter upstream of the wicking pad.

24. The device according to claim 1, further comprising an external pressure source configured to control the flow of the sample through the wicking pad and pathway.

25. The device according to claim 1, further comprising a second wicking pad downstream of the free flow region of the fluid pathway to draw the sample through the device.

26. The device according to claim 1, further comprising an electro-wetting element within the free flow region of the fluid pathway.

27. The device according to claim 1, further comprising an indicator to confirm that a sufficient sample has been provided.

28. The device according to claim 1, wherein the device is enclosed within a housing and wherein the optical element is configured to facilitate TIR for the analysis of the sample by the provision of an opening in the housing to enable light to be incident at or above the critical angle.
